(19) United States
(12) Patent Application Publication
(10) Pub. No.: US 2013/0121776 A1
(43) Pub. Date: May 16, 2013

(54) CUTTING INSERT, CLAMPING DEVICE FOR CUTTING INSERT, AND CUTTING TOOL

(71) Applicant: TUNGALOY CORPORATION, Iwaki-shi (JP)

(72) Inventor: Shinya Majima, Iwaki-shi (JP)

(73) Assignee: TUNGALOY CORPORATION, Iwaki-shi (JP)

(21) Appl. No.: 13/736,684

(22) Filed: Jan. 8, 2013

Related U.S. Application Data
(63) Continuation-in-part of application No. PCT/JP2012/063005, filed on May 22, 2012.

(30) Foreign Application Priority Data
May 23, 2011 (JP) 2011-114433

(51) Int. Cl. B23B 27/16

(52) U.S. Cl. CPC B23B 27/1622; B23B 27/1611
USPC 407/104; 407/113

(57) ABSTRACT

A cutting insert can be clamped by a lever-lock clamping device to a tool body in a more stable and reliable manner. A cutting insert clamped by the clamping device to an insert seat formed on a tool body, includes: an upper surface and a lower surface each having a substantially polygonal contour shape; a plurality of side surfaces extending between the upper surface and the lower surface; a through-hole penetrating through the upper surface and the lower surface; and a concave notch portion for receiving a clamping force that is partially formed at a peripheral edge portion of the through-hole on the upper surface side.

### CROSS-REFERENCE TO RELATED APPLICATIONS

This application is a continuation-in-part of PCT application No. PCT/JP2012/063005, filed May 22, 2012 and published as WO 2012/161176A1, which claims the benefit of Japanese Patent Application 2011-114433, filed May 23, 2011. The contents of the aforementioned applications are incorporated by reference in their entirety.

### BACKGROUND OF THE INVENTION

### Field of the Invention

The present invention relates to a cutting insert clamped to a tool body by a so-called lever-lock clamping device, a clamping device suited for the cutting insert, and a cutting tool including the clamping device.

In the field of cutting tools, there is known a so-called lever-lock method disclosed in Japanese Utility Model Laid-Open No. H07-15204 (1995) as a method for clamping a cutting insert to a tool body, for example. In the lever-lock clamping method, an L-shaped lever member is incorporated into the interior of the tool body, and a clamp portion formed at one end of the lever is pressed against the wall surface of a through-hole of the cutting insert by leverage, thereby to clamp the cutting insert to the insert seat of the tool body. Japanese Patent Laid-Open No. H11-197910 (1999) discloses a clamping device that improves a problem of lifting of a cutting insert in a clamping method of Japanese Utility Model Laid-Open No. H07-15204 (1995).

### SUMMARY OF THE INVENTION

In the lever-lock clamping device as described above, there is a possibility that quality of processing work pieces is deteriorated if clamping is not performed in a stable and reliable manner. Therefore, there conventionally has been demand for more stable and reliable clamping of a cutting insert.

The present invention provides a cutting insert that can be clamped to a tool body by a lever-lock clamping device in a stable and reliable manner.

In addition, the present invention provides a clamping device suited for clamping the cutting insert to a tool body.

Further, the present invention provides a cutting tool including the clamping device.

A cutting insert (1) of the present invention is a cutting insert (1) clamped to an insert seat (22) formed on a tool body (20), including:

an upper surface (2) and a lower surface (3) each having a substantially polygonal contour shape; and a plurality of side surfaces (4) extending between the upper surface (2) and the lower surface (3);

a through-hole (10) penetrating through the upper surface (2) and the lower surface (3); and

a concave notch portion (11) for receiving a clamping force that is partially formed at a peripheral edge portion of the through-hole (10) on the upper surface (2) side.

A clamping device of the present invention is a clamping device that clamps the cutting insert (1), including: a lever member (30) that is swingably supported by the tool body (20), has at a first end portion (31) thereof a clamp portion (33) that is received at the notch portion (11) of the cutting insert (1) so as to abut an abutment surface of the notch portion (11), and receives a force at an opposite second end portion (35) thereof to clamp the cutting insert (1) to an insert seat (22) formed on the tool body (20) by leverage; and a pressure lock mechanism (60) that presses and locks the second end portion (35) of the lever member (30).

A cutting tool of the present invention includes the clamping device.

According to the present invention, relative positions of the lever member and the cutting insert are stabilized, thereby achieving more reliable clamping of the cutting insert.

Further features of the present invention will become apparent from the following description of exemplary embodiments (with reference to the attached drawings).

### BRIEF DESCRIPTION OF THE DRAWINGS

FIG. 1 is a front view of a cutting tool according to a first embodiment of the present invention;

FIG. 2A is a cross section view of FIG. 1 taken along line II-II showing a clamped state;

FIG. 2B is a cross section view of FIG. 1 taken along line II-II showing an unclamped state;

FIG. 3A is a perspective view of a cutting insert according to the first embodiment of the present invention;

FIG. 3B is a top view of the cutting insert of FIG. 3A;

FIG. 3C is a cross section view of FIG. 3B as seen in a direction of line IIIC-IIIC;

FIG. 4 is a top view for describing a formation range of a notch portion in the cutting insert of FIG. 3A;

FIG. 5 is a perspective view showing a structure of a tip end portion of a tool body of the cutting tool of FIG. 1;

FIG. 6A is a perspective view showing a structure of a lever member in the cutting tool of FIG. 1;

FIG. 6B is a perspective view of the lever member of FIG. 6A as seen from another direction;

FIG. 7 is a perspective view of a shim in the cutting tool of FIG. 1;

FIG. 8 is a perspective view of an auxiliary member in the cutting tool of FIG. 1;

FIG. 9 is a perspective view of a cutting insert according to a second embodiment of the present invention; and

FIG. 10 is a perspective view showing a structure of a lever member in a clamping device according to the second embodiment of the present invention.

### DETAILED DESCRIPTION

### First Embodiment

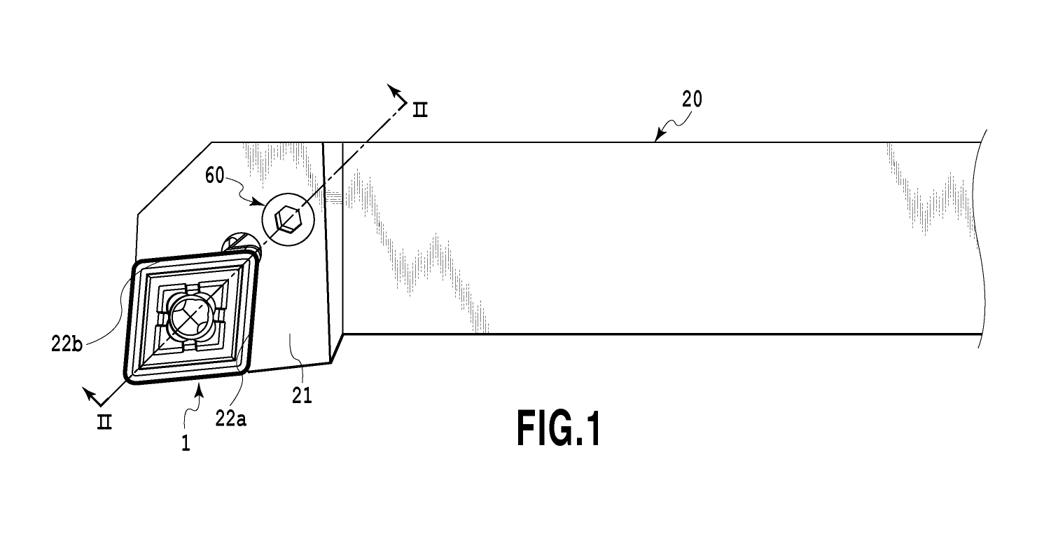

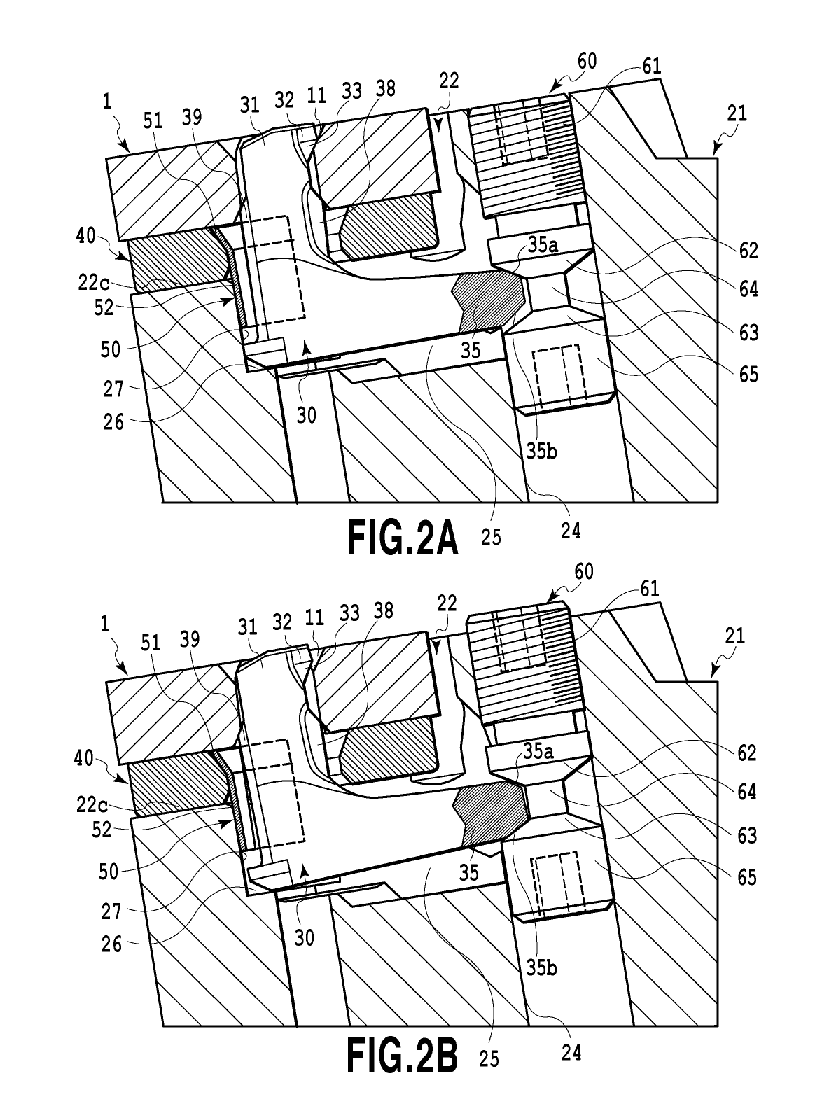

A cutting insert according to the first embodiment of the present invention, a clamping device clamping the cutting insert, and a cutting tool including the clamping device, will be described with reference to the drawings. The cutting tool according to the present embodiment is a turning tool that includes a cutting insert 1, a tool body 20, a lever member 30, a shim 40, an auxiliary member 50, and a lock screw 60, as shown in FIGS. 1, 2A, and 2B.

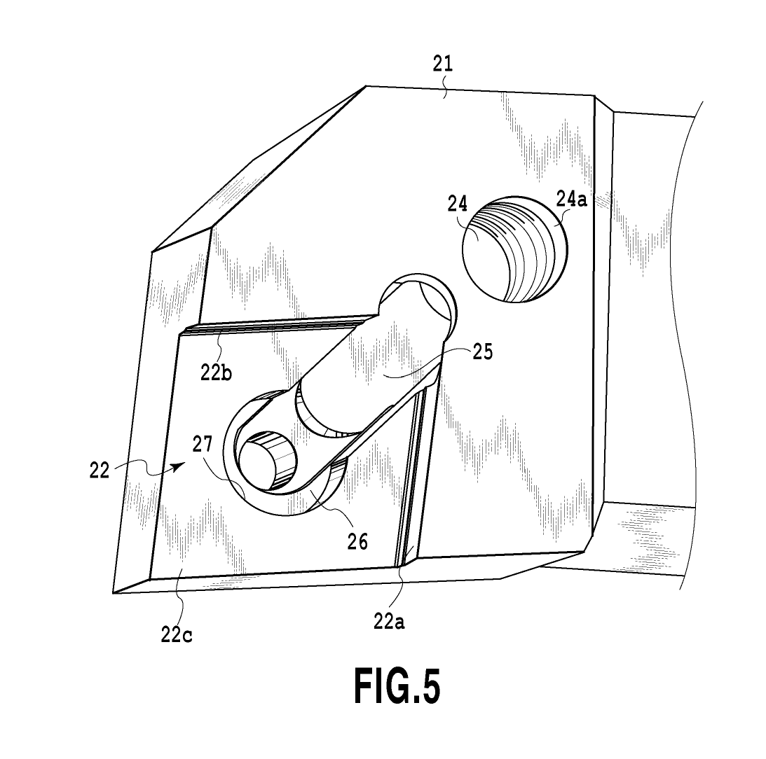

The tool body 20 is formed by a narrow and long bar-like member as shown in FIG. 1, and has an insert seat 22 for attachment of the cutting insert 1 on an upper surface of a tip end portion 21, as shown in FIG. 5.

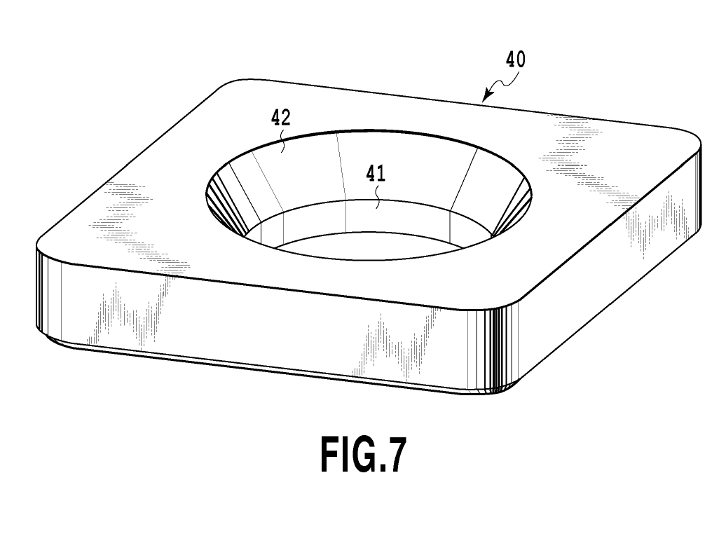

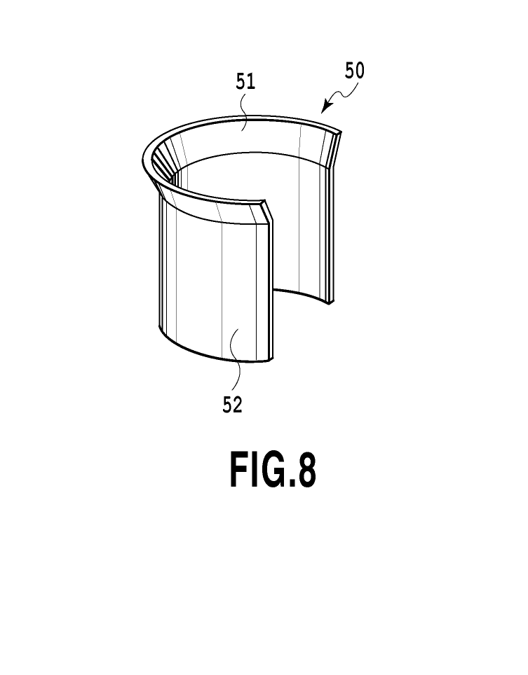

The insert seat 22 is formed in the almost same shape as a contour shape of the cutting insert 1, and is defined by a planar bottom surface 22c, and side wall surfaces 22a and 22b directed so as to be orthogonal to the bottom surface 22c and intersect with each other. The shim 40 shown in FIG. 7 is placed on the bottom surface 22c. The shim 40 is a plate-like member having a rectangular contour shape, and has a through-hole 41 formed at a gravity center portion thereof and has a tapered surface 42 formed at an upper end portion of the through-hole 41. The shim 40 is used to prevent the tool body 20 from being damaged due to a defect of the cutting insert 1 or the like. Even if it is damaged, the shim 40 can be easily replaced. As shown in FIGS. 2A and 2B, the bottom surface 22c of the insert seat 22 is formed to be inclined with respect to a lower surface of the tool body 20, thereby to form a flank when the negative-type cutting insert 1 is attached to the tool body 20.

A guide hole 24 is formed at the tip end portion 21 of the tool body 20 so as to penetrate through the upper and lower surfaces, and a screw portion 24a of the guide hole is formed on the upper surface side of the guide hole 24. In addition, formed at the tip end portion 21 of the tool body 20 is a recessed storage portion 25 that stores and supports the lever member 30 in a swingable manner. The storage portion 25 extends toward the guide hole 24 from a central region of the bottom surface 22c of the insert seat 22, and communicates with the guide hole 24. Formed at the end portion of the storage portion 25 on the side opposite to the guide hole 24 is a support surface 26 in an arc shape for supporting the lever member 30.

The lock screw 60 is formed by a bar-like member as shown in FIGS. 2A and 2B, and has at an upper end portion thereof a threaded portion 61 screwed to the screw portion 24a of the guide hole 24. A diameter-reduced portion 64 is formed in the middle of the lock screw 60 in a longitudinal direction. An upper, first tapered surface 62 is formed in a conical surface shape on the upper side of the diameter-reduced portion 64, and a lower, second tapered surface 63 is formed in a conical surface shape on the lower side of the diameter-reduced portion 64. A fitting portion 65 is formed at the lower end portion of the lock screw 60 and is fitted into the guide hole 24 and guided by the same.

The auxiliary member 50 is formed by a semi-cylindrical member that is partially opened in a circumferential direction. A cylindrical portion 52 has at an upper end thereof a tapered portion 51 that protrudes toward outside. The auxiliary member 50 is fitted and inserted into the through-hole 41 of the shim 40 as shown in FIGS. 2A and 2B, and the cylindrical portion 52 is fitted into a cylindrical inner wall surface 27 of the storage portion 25. When the tapered portion 51 of the auxiliary member 50 engages with the tapered surface 42 of the shim 40, the auxiliary member 50 is prevented from slipping out. When the auxiliary member 50 is fitted into the through-hole 41 of the shim 40 and the cylindrical inner wall surface 27 of the storage portion 25, movement of the shim 40 on the bottom surface 22 of the insert seat 22 is restricted.

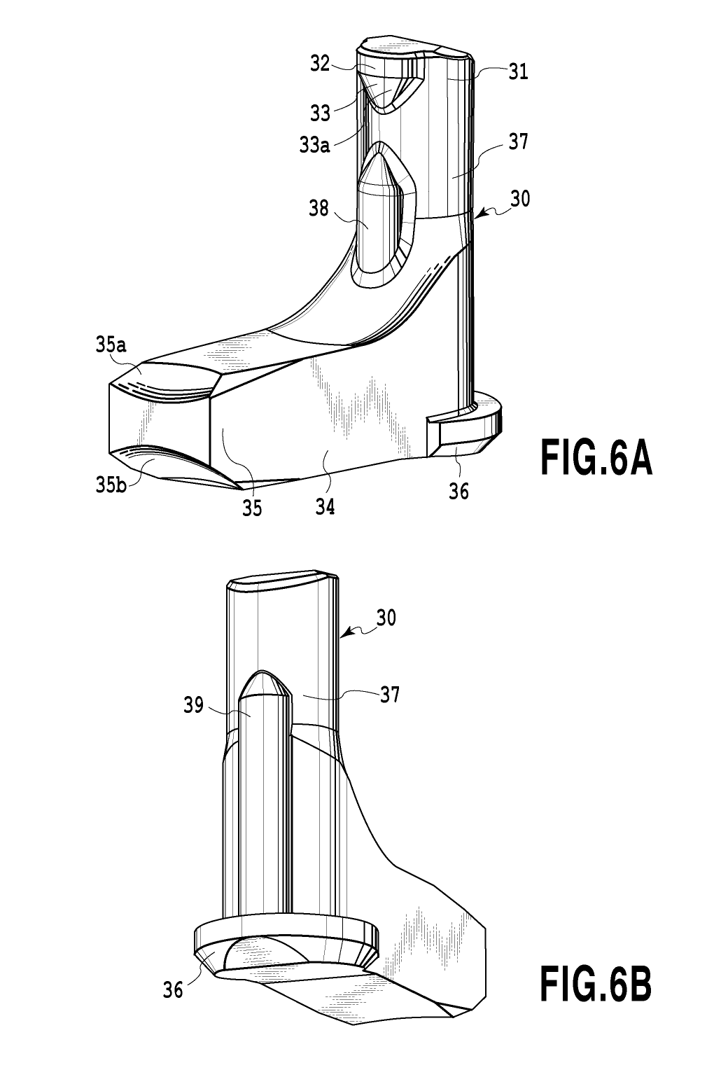

The lever member 30 is L-shaped and has a horizontally extending base portion 34 connected to a shaft portion 37 with a circular cross section, the shaft portion 37 extending from the base portion 34 in a direction substantially orthogonal to the horizontal direction, as shown in FIGS. 6A and 6B.

Formed on an upper surface side of a base tip end portion 35 of the base portion 34 is an upper, first engagement surface 35a engaging with the first tapered surface 62 of the lock screw 60. Formed on a lower surface side of the base tip end portion 35 is a lower, second engagement surface 35b engaging with the second tapered surface 63 of the lock screw 60. The first and second engagement surfaces 35a and 35b are formed in concave curved surfaces coinciding with the first and second tapered surfaces 62 and 63. Formed at a bottom portion of the base portion 34 on a trailing end side is a supported heel portion 36 supported by the support surface 26 of the tool body 20. The lever member 30 is swingable with the supported heel portion 36 as a supporting point.

Formed at a shaft tip end portion 31 of the shaft portion 37 is a shaft tip projection portion 32 projecting toward the base portion 34. Formed under the shaft tip projection portion 32 is a clamp portion 33 for clamping the cutting insert 1. The clamp portion 33 is convexly curved and is defined in shape by an abutment surface 33a configured to abut notch portions 11 of the cutting insert 1 as described later. The abutment surface 33a is formed as a conical surface substantially coinciding with the shape of the notch portions 11 in this embodiment, but is not limited to this shape and may be formed as a flat surface instead of the curved surface.

Formed in an area of connection between the base portion 34 and the shaft portion 37 are two axially extending projection portions 38 and 39 along an axial direction of the shaft portion 37. The axially extending forward projection portion 38 and the axially extending rear projection portion 39 are provided to abut the lower surface side of the cutting insert 1 and raise the cutting insert 1 upon unclamping of the cutting insert 1.

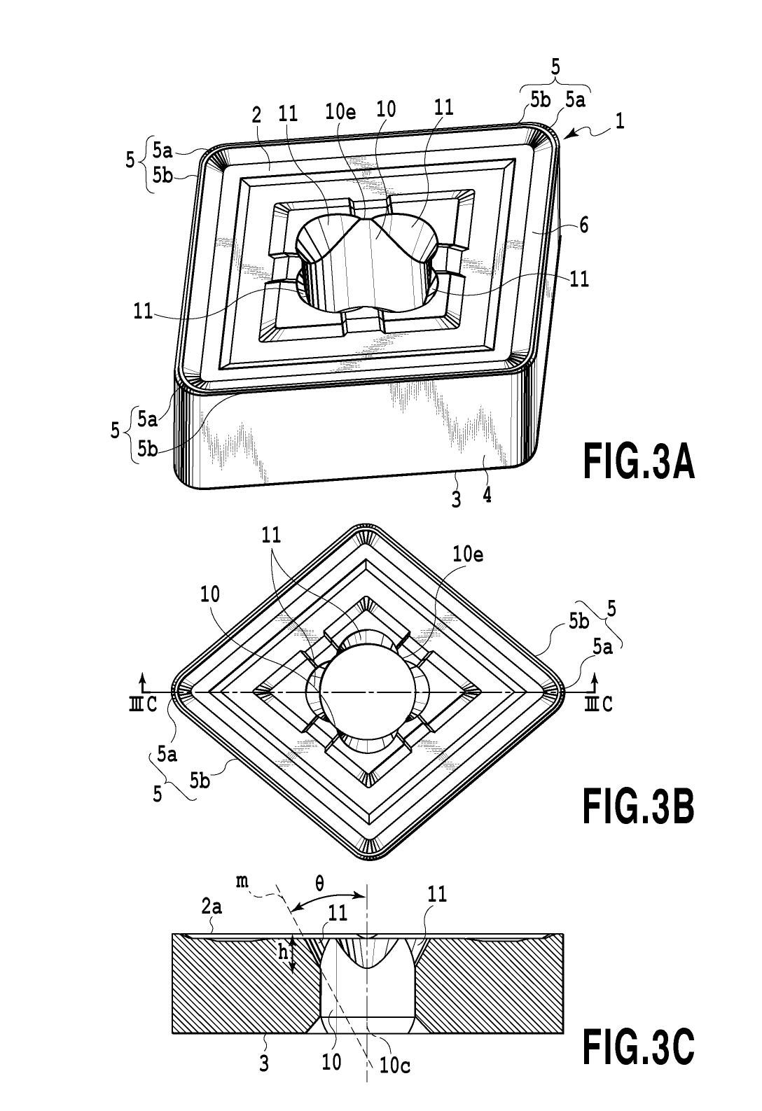

The cutting insert 1 is a plate-like member that has an upper surface 2 and a lower surface 3 each having a substantially parallelogram contour shape, and a plurality of side surfaces 4 extending between the upper surface 2 and the lower surface 3. A cutting edge 5 is formed at an intersection portion of the upper surface 2 and the side surfaces 4. The cutting edge 5 includes corner cutting edges 5a formed at corners and straight cutting edges 5b formed at straight portions. A portion of the upper surface 2 functions as a rake face, and the side surfaces 4 function as flank. Reference surfaces formed by planes of the side surfaces 4 intersect with reference surfaces of the upper surface 2 and the lower surface 3 so as to be orthogonal to the same. Accordingly, the cutting insert 1 is a so-called negative cutting insert. Used for cutting in the cutting insert 1 are corners at which extension lines of the straight cutting edges 5b intersect at an acute angle, that is, acute-angle corner neighborhoods, specifically, right and left two corners shown in FIG. 3B.

Formed on the upper surface 2 is a groove-like chip breaker 6 along the cutting edge 5. The chip breaker 6 applies a breaking force to generated chips to cut the chips in an appropriate length. Of surfaces constituting the chip breaker 6, inclined surfaces located on the side nearer to the cutting edge 5 function as rake faces.

Formed at a position of a gravity center of the cutting insert 1 is a through-hole 10 with a circular cross section penetrating through the upper surface 2 and the lower surface 3. The through-hole 10 is formed with an inner diameter that allows the shaft tip end portion 31 of the lever member 30 to pass therethrough.

A plurality of concave notch portions 11 are partially formed at a peripheral edge portion 10e of the through-hole 10 on the upper surface 2 side. The notch portions 11 are provided to receive the clamp portion 33 formed at the lever member 30 and contact the clamp portion 33. The notch portions 11 are defined by concave curved surfaces. In this embodiment, the curved surfaces of the notch portions 11 are formed in a conical surface substantially coinciding with the shape of the clamp portion 33. Preferably, the clamp portion 33 is slightly smaller in radius of curvature than curved surfaces of the notch portions 11. Note that, the present invention is not limited to these curved surfaces.

As in the foregoing, when the notch portions 11 and the clamp portion 33 are formed so as to coincide with each other, the relative positional relationship between the cutting insert 1 and the lever member 30 is stabilized. In addition, when the notch portions 11 and the clamp portion 33 engage with each other, the rotation of the cutting insert 1 around the center axis line 10c of the through-hole 10 is restricted. The shape of a surface that defines the notch portions 11 and the clamp portion 33 can be appropriately set, and the notch portions 11 and the clamp portion 33 may contact with each other at a point, line, or surface. Further, as shown in FIG. 3C, in a cross section that passes through the center axis line 10c of the through-hole 10 and bisects the two opposing acute-angle corners 5a, an angle θ formed by a generatrix m of the conical surface of the notch portions 11 and the center axis line 10c, is preferably set within a range of 10 to 45°. If the angle θ is larger than 45°, the notch portions 11 account for too large an area. If the angle θ is smaller than 10°, the lever member 30 produces a decreased force of pressing the cutting insert 1 in a direction vertical to the bottom surface 22c of the insert seat 22. A depth h of the notch portions 11 in the thickness direction of the cutting insert 1 is preferably 10% or more and 40% or less, more preferably 20% or more and 30% or less of the thickness of the cutting insert 1.

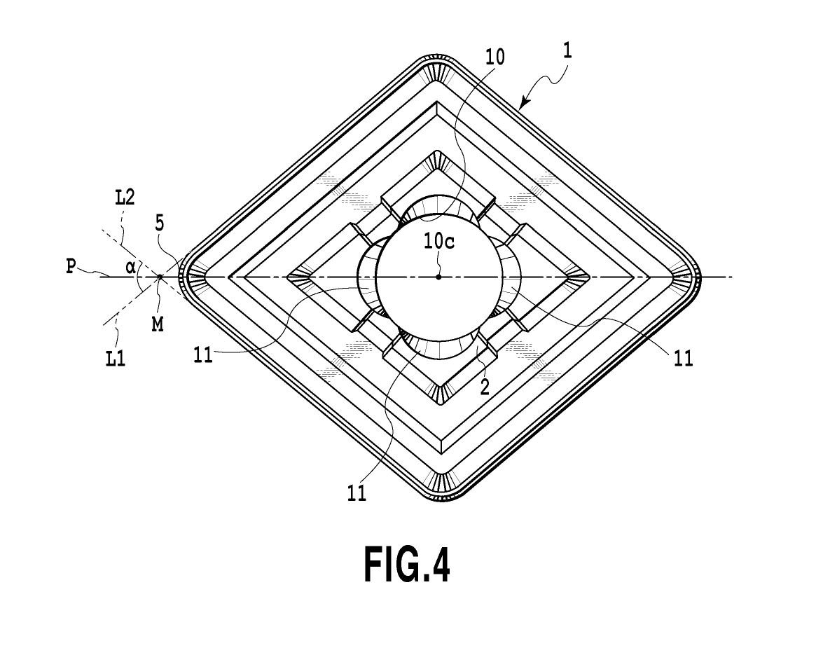

A preferred position for formation of the notch portions 11 at the peripheral edge portion 10e of the through-hole 10 will be described below. As shown in FIGS. 3A to 3C, the notch portions 11 are formed in positions at a shortest distance from the corresponding corner cutting edges (corner portions) 5a at the peripheral edge portion 10e of the through-hole 10. Further, the notch portions 11 are formed symmetric with respect to a plane P bisecting an angle α at the corner portions formed by straight lines L1 and L2 extending from the straight cutting edges 5b, in a plan view shown in FIG. 4. In other words, the notch portions 11 are symmetric with respect to a plane P that contains center axis line 10c of the through-hole 10 and bisects opposite corner cutting edges 5a. In addition, positions for formation of the notch portions 11 are decided in the same manner if the corners on the obtuse angle sides are used as cutting edges.

Next, an operation of the clamping device configured as described above will be described with reference to FIGS. 2A and 2B. FIG. 2A shows a clamped state, and FIG. 2B shows an unclamped state. In the unclamped state shown in FIG. 2B, the clamp portion 33 of the lever member 30 is not pressed against the notch portions 11.

When the lock screw 60 is rotated in an upward direction, the lower, second tapered surface 63 of the lock screw 60 engages with the lower, second engagement surface 35b of the lever member 30 to press and raise the lever member 30 upward. At that time, upper end portions of the axially extending projection portions 38 and 39 of the lever member 30 abut the lower surface of the cutting insert 1 to separate the cutting insert 1 from the shim 40. Then, when the cutting insert 1 is pulled out from the shaft tip end portion 31 of the lever member 30, the cutting insert 1 can be removed from the insert seat 22.

When the lock screw 60 is rotated in a downward direction, the upper, first tapered surface 62 of the lock screw 60 engages with the upper, second engagement surface 35b of the lever member 30 to press the base tip end portion 35 of the lever member 30 downward, as shown in FIG. 2A. Since the lever member 30 is swingably supported with the supported heel portion 36 as a supporting point, the clamp portion 33 of the lever member 30 is pressed against the notch portions 11 of the cutting insert 1. The lever member 30 amplifies a force received from the lock screw 60 by leverage, and transfers the force to the notch portions 11.

Under a clamping force acting on the cutting insert 1 from the clamp portion 33 fitted into the notch portions 11, the cutting insert 1 is pressed toward the side wall surfaces 22a and 22b of the insert seat 22, and also is pressed toward the bottom surface 22c via the shim 40. As a result, the cutting insert 1 is clamped to the insert seat 22. In this clamped state, since the clamp portion 33 engages with the notch portions 11, the relative positional relationship between the cutting insert 1 and the lever member 30 is stabilized, which allows the cutting insert 1 to be clamped in a stable and reliable manner. In particular, when the clamp portion 33 engages with the notch portions 11, the rotation of the cutting insert 1 around the center axis line 10c is restricted, and variations in position of the cutting edge 5 of the cutting insert 1 during cutting operation are suppressed.

### Second Embodiment

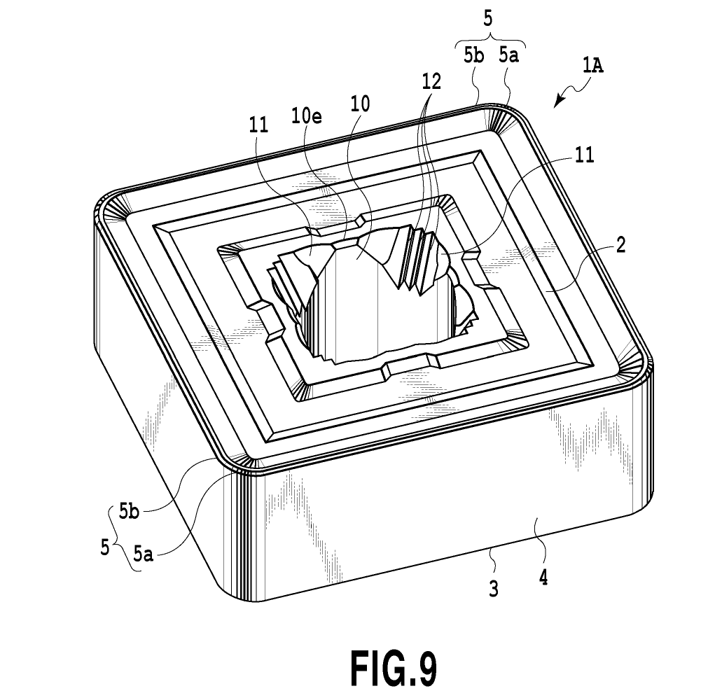

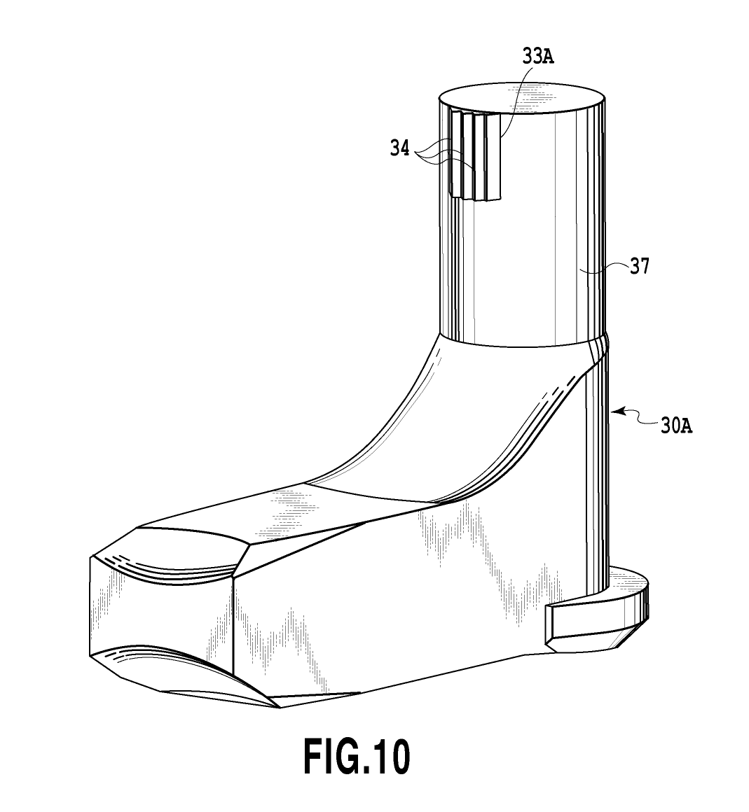

A cutting insert and a clamping device according to a second embodiment of the present invention will be described below with reference to FIGS. 9 and 10. In FIGS. 9 and 10, the same components as those in the first embodiment are given the same reference numerals as those in the first embodiment. The second embodiment is identical in configuration to the first embodiment, except for the cutting insert and the lever member.

A cutting insert 1A according to this embodiment has notch portions 11A formed at the peripheral edge portion 10e of the through-hole 10. However, serrations (convexities and concaves) 12 are formed at the notch portions 11A.

The cutting insert 1A is clamped to the insert seat 22 of the tool main body 20 using a lever member 30A sown in FIG. 10. The lever member 30A has a cylindrical surface-shaped clamp portion 33A formed at a shank tip end portion of the shaft portion 37. The clamp portion 33A is formed so as to fit into the notch portions 11A of the cutting insert 1A. The clamp portion 33A has serrations 34 which can engage with the serrations 12 formed at the notch portions 11A, formed along the longitudinal direction of the shaft portion 37.

When the serrations 12 of the notch portions 11A and the serrations 34 of the lever member 30A engage with each other, it is possible to suppress sliding and displacement of the lever member 30A on the notch portions 11A during a cutting operation. As a result, it is possible to further suppress micro vibration of the cutting insert 1A at the insert seat and improve quality of a cutting surface.

The cutting insert, the clamping device, and the cutting tool in the present invention are not limited by the shapes described above. For example, the clamp portion 30 of the lever member and the notch portions 11 of the cutting insert 1 receiving the clamp portion 30 may be divided in a plurality of portions. Specifically, the clamping device and the cutting tool may be configured to include a lever member having clamp portions that can press a plurality of individual notch portions.

In addition, in the foregoing embodiment, the chip breaker and the notch portions are formed only on the upper surface 2, but may also be formed on the lower surface. The lock screw 60 may not be moved vertically by a screw as described above, but may be configured to have a rotational member including a cam, for example, so that the lever member is pressed down by the cam portion. In this configuration, the lock screw 60 can be designed so as to be easily operated from a side surface of the tool body 20. With regard to the form of the cutting tool, too, the present invention is applicable not only to turning tools as described above but also to other cutting tools such as rotating tools and the like.

In the foregoing embodiment, the cutting edge 5 includes a combination of corner cutting edges 5a and straight cutting edges 5b. Alternatively, the cutting edge 5 may have waveform cutting edges instead of the straight cutting edges.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A cutting insert for clamping to an insert seat formed on a tool body, comprising:
an upper surface and a lower surface each having a substantially polygonal contour shape;
a plurality of side surfaces extending between the upper surface and the lower surface;
a through-hole penetrating through the upper surface and the lower surface; and
a concave notch portion for receiving a clamping force, the notch portion being partially formed at a peripheral edge portion of the through-hole on the upper surface side.

2. The cutting insert according to claim 1, wherein the notch portion is formed by a concave curved surface.

3. The cutting insert according to claim 2, wherein the curved surface is formed as a conical surface.

4. The cutting insert according to claim 3, wherein an angle formed by a generatrix of the conical surface and a center axis line of the through-hole, falls within a range of 10 to 45°.

5. The cutting insert according to claim 1, wherein:
the notch portion comprises a plurality of serrations.

6. The cutting insert according to claim 1, wherein:
an intersecting portion between the upper surface and the side surfaces has a corner portion; and
the notch portion is formed in a position at a shortest distance from the corner portion at a peripheral edge portion of the through-hole.

7. The cutting insert according to claim 6, wherein:
the notch portion is formed symmetric with respect to a plane bisecting an angle at the corner portion in a plan view.

8. A cutting tool comprising:
a tool body having an insert seat;
a cutting insert according to claim 1 seated in the insert seat; and
a clamping device comprising a clamp portion configured to clamp the cutting insert, upon abutment of the clamp portion against the notch portion.

9. The cutting tool according to claim 8, wherein
the clamping device is a lever-lock clamping device having a lever member,
a first end portion of the lever member is configured to pass through the cutting insert through-hole, and
the clamp portion is formed at the first end portion of the lever member.

10. The cutting tool according to claim 9, wherein the notch portion of the cutting insert has a shape substantially coinciding with a shape of the clamp portion.

11. The cutting tool according to claim 10, wherein:
the notch portion of the cutting insert comprises a plurality of serrations;
the clamp portion of the lever member comprises a plurality of serrations; and
the serrations on the clamp portion are configured to engage with the serrations formed on the notch portion, when the lever member clamps the cutting insert.

12. The cutting tool according to claim 9, wherein:
the lever member is swingably supported by the tool body,
the lever member receives a force at an opposite, second end portion thereof to clamp the cutting insert to the insert seat by leverage, and
a pressure lock mechanism presses and locks the opposite, second end portion of the lever member.

13. The cutting tool according to claim 12, wherein
the pressure lock mechanism comprises:
a guide hole that is formed in the tool body and has a screw portion; and
a lock screw including a threaded portion screwed to the screw portion, first and second tapered surfaces that are engageable with the second end portion of the lever member, and a fitting portion guided by the guide hole, and wherein
the lock screw is configured to rotate in a first direction to move the lever member in a direction bringing the lever member into a clamped state, and rotate in a second direction to move the lever member in a direction bringing the lever member into an unclamped state.

14. The cutting tool according to claim 12, wherein the clamp portion has an abutment surface curved in a convex shape.

15. The cutting tool according to claim 12, wherein the clamp portion has a shape substantially coinciding with a shape of the notch portion.

16. The cutting tool according to claim 12, wherein the clamp portion has a projection or a recess engaging with a recess or a projection formed at the notch portion.

17. The cutting tool according to claim 9, wherein:
the lever member comprises an axially extending forward projection portion and an axially extending rear projection portion; and
the axially extending forward projection portion and the axially extending rear projection portion are configured to abut the lower surface of the cutting insert and raise the cutting insert, when the cutting insert is unclamped.

18. The cutting tool according to claim 9, further comprising:
a shim positioned on the insert seat beneath the cutting insert, the shim comprising a shim through hole surrounded by a tapered surface; and
an auxiliary member comprising a cylindrical portion having a outwardly tapered portion formed on an upper end thereof; wherein:
the auxiliary member is fitted into the through-hole of the shim, with the tapered portion of the auxiliary member engaging the tapered surface of the shim.

19. A tool body having an insert seat, and comprising:
a guide hole formed at a tip portion of the tool body adjacent the insert seat, the guide hole having a screw portion;
a storage portion formed in the insert seat, the storage portion extending toward the guide hole from a central region of a bottom surface of the insert seat, and communicating with the guide hole, the storage portion having a support surface formed at an end portion on a side opposite to the guide hole;
a L-shaped a lever member seated in the storage portion and comprising:
a shaft portion having a shaft tip end portion provided with a clamp portion,
a base portion connected to the shaft portion having a base tip end portion provided with an upper, first engagement surface and a lower, second engagement surface;
a lock screw comprising:
a threaded portion formed on an upper end portion of the lock screw and screwed to the screw portion of the guide hole;
first and second tapered surfaces that are engageable with the first and second engagement surfaces provided on the base tip end portion of the lever member base portion; and
a fitting portion formed on a lower end portion of the lock screw, on a side opposite the first and second tapered surfaces from the threaded portion, the fitting portion occupying guide hole;
wherein:
the lever member is swingably supported by the tool body; and
the lock screw is configured to rotate in a first direction to move the lever member in a direction bringing the lever member into a clamped state, and rotate in a second direction to move the lever member in a direction bringing the lever member into an unclamped state.

20. The tool body according to claim 19, further comprising:
a shim positioned on the insert seat, the shim comprising a shim through hole surrounded by a tapered surface; and
an auxiliary member comprising a cylindrical portion having a outwardly tapered portion formed on an upper end thereof; wherein
the auxiliary member is fitted into the through-hole of the shim, with the tapered portion of the auxiliary member engaging the tapered surface of the shim; and
the cylindrical portion of the auxiliary member is fitted into a cylindrical inner wall surface of the storage portion.
